(19) United States
(12) Patent Application Publication
(10) Pub. No.: US 2005/0269892 A1
(43) Pub. Date: Dec. 8, 2005

(54) Induction machine rotors with improved frequency response

(76) Inventor: William B. Duff JR., Odessa, TX (US)

Correspondence Address: DALLAS OFFICE OF FULBRIGHT & JAWORSKI L.L.P., 2200 ROSS AVENUE, SUITE 2800, DALLAS, TX, 75201-2784, US

(21) Appl. No.: 11/127,781

(22) Filed: May 12, 2005

Related U.S. Application Data
(60) Provisional application No. 60/571,975, filed on May 18, 2004.

(51) Int. Cl. H02K 17/18

(52) U.S. Cl. 310/212

(57) ABSTRACT

The present invention generally relates to the use of electrical charge storage devices in the rotors of induction machines. Optimal induction machine rotor electrical field requirements increase with rotational velocity and inversely to frequency. Pseudocapacitance and other inverse frequency capacitance adjustment methods are employed to provide for that need and thereby improve induction machine rotor performance parameters. Optimization of electrical reactance is the foundation for improvements in power transfer, torque, efficiency, stability, thermodynamics, vibration, thermodynamics and bearing life in rotational induction machines. LC rotor methods and designs are outlined herein to achieve these objectives.

### CROSS-REFERENCE TO RELATED APPLICATIONS

This application claims priority to U.S. Provisional Patent Application Ser. No. 60/571,975 entitled “INDUCTION MACHINE ROTORS WITH IMPROVED FREQUENCY RESPONSE”, filed May 18, 2004, which is hereby incorporated herein by reference.

### TECHNICAL FIELD

The present invention generally relates to the use of electrical charge storage devices in rotors. In particular, the present invention relates to electrical charge storage devices, such as capacitors, in induction machine rotors for improved frequency response

### BACKGROUND OF THE INVENTION

Conversion of electrical energy to useful work consumes a great quantity of electrical power. There are therefore significant advantages to improving the operational parameters of their energy conversion mechanisms. The rotor is the ultimate point of electrical load in electromagnetic energy conversion to useful rotational work. The frequency response of rotors has heretofore posed a great challenge and difficulty.

AC Frequency: Most AC electrical power generation, transmission and distribution grids operate at a fixed fundamental frequency of 50 or 60 Hertz. Other fundamental frequencies are in use, for example 25 and 400 Hertz. Regions are typically synchronized and phase locked to the selected fundamental frequency. DC generation, transmission and asynchronous ties are used to transfer power between these regions. Where other frequencies or variable frequencies are desirable for use in specific locations or applications, a frequency converter or adjustable frequency device is placed in service. Motor generator sets and power electronic frequency converters and adjustable speed drives are commonly available products with these capabilities.

Harmonic Frequency Distortion: Harmonic and subharmonic frequencies are often superimposed upon the fundamental frequency. For the case of a 60 Hertz fundamental frequency, the 2nd, 3rd and 4th harmonic frequencies would be 120, 180 and 240 Hz. Troublesome frequencies include 5th harmonic and triplen harmonics such as the 3rd, 9th and 15th harmonics. Subharmonic frequencies would include the ½ (30 Hz) and ⅓ (20 Hz) subharmonic. The presence of significant levels of subharmonic and harmonic frequencies and especially resonances at these frequencies can pose significant difficulties to reliable operation of the grid and connected equipment. Many electrical sources and loads produce or are sensitive to harmonic or subharmonic distortion.

Frequency Response: Electrical components and systems typically change in function, behavior and characteristics in response to frequency variations. These variations of performance are typically graphed in the form of frequency response curves. The composition of the electrical components and systems can often be altered to minimize, maximize, linearize or flatten their frequency response. The frequency response of a given material or system is a routine engineering design consideration. Electrical designs of amplifiers, speakers, adjustable frequency drives as well as many other electrical devices and systems are primarily focused upon the system frequency response. Various complexity mathematic, heuristic and circuit models are employed to account for frequency related performance variation of components, subsystems and systems. Frequency response is a significant consideration even in fixed frequency systems and devices such as power grids due to the presence of harmonics, subharmonics, stray resonances and the like. Materials, designs, processes and implementations exist to select, alter and tune frequency responses.

Capacitors: Electrical capacitors are well known fundamental electrical circuit elements that store electrical energy in an electrical field. A common capacitor type, the flat plate capacitor is composed of two electrical conductors that are separated by an electrical insulator or dielectric material. The capacitance of flat plate type electrical capacitors is typically mathematically modeled by the surface area of the plates (A), distance separating the plates (D) and the electrical properties of the dielectric (E) as shown below in Equation 1, titled Flat Plate Capacitance Formula. There are two generalized capacitor technologies, non polarized and polarized. There are known mechanisms and methods for interchanged use of polarized and non polarized capacitors. Several common nonpolarized electrical capacitor technologies include, kraft paper, oil filled and metalized film. Several common polarized capacitor technologies include: electrolytic, tantalum, super capacitors, ultra capacitors and double layer capacitors. Electrical current leads voltage in capacitors and capacitive circuits.

### Equation 1: Flat Plate Capacitance Formula

$$c = \frac{EA}{D}$$

Capacitors at the Load: Shunt capacitors operate primarily as a current source. Series capacitors primarily act as a voltage source. Therefore hybrid capacitor topologies can be configured for a number of circuit needs. It is generally recognized that significant benefits accrue to AC electrical systems where series, shunt and hybrid capacitors are located at or near the point of the electrical load. The benefits of these capacitors often tend to decrease with distance from the load.

Variable capacitors: A simple method of capacitance variation is by adding additional capacitors in shunt (to increase) and in series to decrease capacitance. It can be clearly seen from Equation 1 that several mechanisms exist whereby capacitance can be varied. The radio frequency tuner on radios is typically a variable capacitor that operates by means of moving an array of parallel plate capacitor conductor surfaces to greater or lesser alignment and overlap. This mechanism varies the surface area (A) parameter of equation 1. Capacitance can also be altered by a variation of plate separation (D). Various additional mechanisms exist for variation of dielectric parameters, for example, inserting a high dielectric constant (E) sheet between the plates of an air gapped set of flat plates. Capacitance in polarized capacitors also varies significantly with electrolyte temperature.

Pseudo Capacitance: Certain electrical capacitors demonstrate a profound decrease in capacitance with frequency increases. This can be restated as: these capacitor implementations increase dramatically in capacitance in response to a decrease in frequency. This phenomenon is sometimes referred to as pseudocapacitance. A generalized graph of capacitance versus frequency in these devices is shown in FIG. 1, titled Pseudocapacitance. Pseudocapacitance is most pronounced in the polarized capacitors such as double layer capacitors, super capacitors, ultra-capacitors, tantalum capacitors, niobium capacitors and electrolytic capacitors. The capacitance of these devices is maximized at or near DC. A similar phenomenon occurs at higher frequencies due to electrical lead inductance. While the generalized capacitive frequency response curve shape of all the polarized electrical charge storage devices is similar, the frequency response of other electrical parameters, such as resistance varies significantly. The relationship of frequency, capacitance and resistance is sometimes denoted the dissipation factor curve.

These capacitors exhibit a self resonant frequency at which the predominant electrical parameter is resistance. Above that frequency, their circuit behavior is somewhat inductive in nature. This phenomenon can in some cases be characterized as a relaxation time for charge storage and discharge. Various mechanisms for pseudocapacitance have been identified in the literature, including adsorption and redox pseudocapacitance. Capacitance in these devices also varies with electrolyte temperature. Each polarized capacitor technology has a known frequency response. The frequency response will generally include variations in capacitance, inductance and resistance mathematical modeling parameters. The electrical resistance parameters of these technologies also vary significantly with temperature. A parallel set of capacitors of differing frequency characteristics can be employed to tailor make a desired overall frequency response. This design technique is referred to as polishing.

Inductors: Electrical inductance and the construction of inductors is similarly a well explored field within the discipline of electromagnetism. Inductors store energy in a magnetic field. Chokes, transformers, electromagnets, motors and generators are common examples of electrical inductors. Inductors are so named based on the property that electromagnetic signals and forces can be induced at a distance in these devices by various known means. Magnetic induction is typically mathematically calculated as a function of frequency, material and distance. Induction is greatly amplified in the presence of ferromagnetic materials such as iron, nickel and cobalt. Alloys of these materials and many other induction enhancing materials are routinely used in electromagnetic designs. The electrical characteristics of inductors are typically mathematically modeled by hysteresis and loss curves. Electrical current lags behind voltage in inductors and inductive circuits.

Hysteresis and Saturation: The relationship between the AC electrical voltage and current in magnetic circuit elements and inductive circuits operating at a defined frequency and temperature is a complex function which is typically described by a hysteresis curve. These curves are well known to those in the field. The typical hysteresis curve is complex but is generally modeled by a linear region, soft saturation region and saturation region.

Frequency response of Inductors and Capacitors: Inductors and capacitors exhibit frequency dependant behavior. For example the energy storage and inductive coupling capabilities of inductors increase with frequency. An increase in inductor mass of approximately 25% is required for converting 60 Hertz transformers and motors over to 50 Hertz service. Inductors are a short in DC applications and will approach an open circuit at high frequency. Capacitors are by contrast an open circuit in DC, and will approach an electrical short at high frequency.

Reactance: The electrical parameter that mathematically correlates the electrical circuit behavior of inductors and capacitors at a selected frequency is the term reactance. Electrical reactance relates AC voltage to current in a manner similar to electrical resistance. Capacitive reactance and inductive reactances can cancel each other out leaving only circuit resistance to correlate AC voltage to AC current. Electrical reactance is frequency dependant. Thus inductive reactance tends to increase with frequency while capacitive reactance generally decreases with frequency. Capacitive reactance is given is Equation 2 below as a quotient including a numerator of 1 and a denominator composed of a 90 degree phasor shifting function (J), a radian frequency of 2 Pi times the frequency in Hertz and the capacitance of the capacitor.

### Equation 2: Capacitive Reactance

$${X}_{C} = \frac{1}{JWC}$$

Inductive reactance is given by the same JW function times the inductance (L) of the inductor as given below in Equation 3. From these equations it is clear that the circuit frequency response of ideal inductors and ideal capacitors is quite opposite. The exact circuit behavior, of real electrical components, is of course somewhat more complex than these mathematical modeling approximations.

### Inductive Reactance

X_{L}=JWL Equation 3

Power Factor: Power factor is a classical mathematical tool for modeling AC electrical circuits. The power factor can be used to correlate the AC voltage, current and angular phase displacement to the watts sourced or sinked by that circuit. Inductive loads, which comprise the bulk of electrical grid loads, are characterized by a lagging power factor. Capacitive loads are characterized by a leading power factor. When the inductive and capacitive loads are exactly balanced the circuit will exhibit a unity power factor. In this condition, the electrical voltage and current are phase locked together. This electrical reactance balance of magnitudes is shown below in Equation 4, titled Ideal Series LC Resonance Condition, which neglects resistance. Equation 5, titled Series LC Resonance Equality, restates this magnitude relation. There are well known analogous formulae for ideal shunt resonance. More complex series and shunt resonance formulae, including resistance effects are also well known within the field. The formulae for hybrid resonance and quasi-resonance can be derived or modeled.

### Ideal Series LC Resonance Condition

X_{L}=X_{C} Equation 4

### Equation 5: Series LC Resonance Equality

$$\frac{1}{JWC} = JWL$$

Power Transfer Theorem: It is well known to those in the field that AC electrical power transfer is optimized at unity power factor. This occurs when inductive reactance equals capacitive reactance. This is described in various statements of the Power Transfer Theorem. Similarly electrical resonance and quasiresonance are well explored electrical phenomena. The forces unleashed in resonance related phenomena approach the infinite. Of course resistance, losses and work serve to damp these forces in realizable devices. These subjects are routinely encountered and employed in the transmission, distribution and conversion of electrical power. One general condition of unity power factor or resonance in simple electrical circuits is for the inductive reactance to equal the capacitive reactance. Since most useful electrical loads are inductive, capacitors are typically added to the electrical grid to increase the power factor and thereby maximize the transfer of electrical power to the load. Power transfer is generally maximized when the source and load are complex conjugates of each other.

Transformers: AC current in one conductor is well known to cause or induce an AC current of the same frequency in a nearby conductor. This will take place in a vacuum, air or through an insulator. When an un-powered wire is adjacent and parallel to a power line this process is observed. This is a common occurrence when for example a phone line or other conductor is run directly below one phase wire of a power utility line. The conventional phone wire, which is typically powered to perhaps 48 Volts DC, will gradually increase in AC voltage as the length of the parallel path increases. The phone company alternates their lines to opposite sides of the utility pole to avoid tracking a single phase conductor over long parallel paths. Similarly the power company sequentially weaves the phase conductors to minimize this effect.

This process of induction is greatly increased in the presence of iron, cobalt, nickel and other ferromagnetic materials. Transformer action is based on this induction. In a voltage transformer, two conductors are wound around a magnetic core in a fixed ratio of turns. The magnetic core can be solid or composed of thin plates interleaved in the shape of a window. The conductors are often wound around the opposite posts of the transformer core. The low voltage conductor has a few turns of large diameter wire. The high voltage side of the transformer has many turns of a smaller diameter conductor. One of the conductors is connected to an AC power source. The other conductor line will then be energized by magnetic induction to an AC voltage that is quite close to the ratio of its number of turns divided by the number of turns of the conductor connected to the power source. The step down voltage transformer is routinely used to transfer electrical power from high voltage distribution lines to the lower and safer common household voltage levels. The process of induction may also be altered and controlled by the use of certain nonmagnetic materials such as monel and hastalloy.

Chokes: An electrical choke is typically composed of an iron core with a single conductor wound around it. Electrical chokes generally include an open gap rather than a continuous core such as used in transformers. The gap can be air or may be filled with an electrical insulating material commonly called a dielectric. The choke has certain well documented electrical effects which are commonly employed in electrical circuit designs. The core shape, material and air gap distance figure prominently in the electrical and magnetic properties of the choke. In some configurations this type of device can be designed for use as an electromagnet. Other choke designs are commonly employed in electrical filter applications. Other useful electrical products, including electrical motors are designed using conductor wound magnetic cores that deliberately include an air gap.

Electric Machines: Almost all electric machines are based on exploiting two basic phenomena: the force exerted on an electric current in a magnetic field and the force produced between ferromagnetic structures carrying a magnetic flux. In most rotating machinery, the torque is mainly exerted on the iron core of the rotor, and only a small torque is exerted directly on the coil.

Motors and Generators: In general, the energy conversion processes of electrical motors and generators are reversible but with losses and hysteresis curves. They operate by means of the phenomenon of induction, wherein the stator induces electromagnetic forces in the rotor when acting in motor mode. There are several useful electromotive force machines including linear and rotary motors. Rotary motors come in a number of types which include a mechanically fixed side called the stator and a rotating member referred to as the rotor. The stator side of the AC induction motor is generally powered by AC or commutated DC, which induces electromotive forces and power in the rotor and causes rotation. Conversely when the rotor is mechanically driven, these devices will then tend to generate electricity, thus acting in generator mode.

Synchronous and Asynchronous Rotary Machines: AC motors are generally either synchronous or asynchronous types. Synchronous motors rotate at exactly the source frequency scaled by the pole pair count, while asynchronous motors exhibit a slower speed characterized by the presence of slip. The rotors of conventional asynchronous induction machines are generally either of squirrel cage construction or wound rotor construction. As the rotor of an asynchronous motor approaches the velocity of the rotating magnetic field, the frequency of the electricity induced in the rotor decreases. At limit as synchronous speed is approached is DC. Thus no torque is created for an asynchronous motor operating at this synchronous velocity.

Conventional Rotor types: The two most common conventional designs for AC induction motors include the squirrel cage and wound rotor types. The shaft, iron core and most of the rotor conductor bars are omitted from the simple sketch in FIG. 2. While no actual squirrel is present inside AC induction motors, the squirrel cage rotor does have a familiar shape. The construction of wound rotor AC induction machines is similarly well known to those in the field. Other rotor types such as DC rotors and synchronous rotors are also quite familiar to those in the field.

Revolving Magnetic Field: The production of a rotating magnetic field using electric currents is the basis for the induction machine invented by Nicola Tesla in 1883. A rotating or revolving magnetic field is easily established in the stator of three phase motors. Motors operating on single phase electricity must generally create a rotating magnetic field by other known design methods. Shaded pole, capacitor run and capacitor start motors are relatively well known stator designs for inducing a revolving magnetic field in an induction machine operating on a single phase power supply. There are known methods for operating three phase induction motors from single phase sources.

Motor Speed: The rotational velocity of induction AC motors is a function of the number of pairs of electrical poles, load related slip and the electrical frequency. Synchronous motors driven at 60 Hertz will spin at 60 revolutions per second or 3600 RPM with a single pair of poles (1PP) or with additional poles, 1800 (2PP), 1200 (3PP), 900 (4PP) and so forth. Asynchronous AC motors driven with the same frequency will slip to rated load speeds on the order of 3580 RPM, 1752 RPM and the like. Adjustable speed drives and similar devices generally connect a frequency converter to an induction motor. By appropriate variations of the frequency and voltage or current of the drive, the rotational velocity and/or torque of the rotor is varied. The drive may be able to operate over a wide range of frequencies and thus, rotational velocities.

Rotor Frequency: The electrical frequency circulating in the rotor of AC induction motors varies with the rotational velocity of the rotor. As the rotor increases in rotational velocity or speed the frequency coupled from the stator begins to decrease. The predominant frequency seen by a rotor spinning at one half of its designed synchronous speed will be on the order of half the frequency that the stator is connected to. When the rotor is spinning at three quarters of synchronous speed the frequency of the rotor voltage and current is approximately one fourth of the fundamental frequency. When the stator is connected to a 60 Hz source, the rotor electrical frequency may range from as low as 0.3 Hz in large machines to 3 Hz in smaller machines.

As a rotor approaches synchronous speed, the electrical current frequency in the rotor approaches DC. Since induction is a function of electrical frequency, no induction occurs at DC. Therefore an AC induction motor cannot produce any torque when it is spinning at synchronous speed. Similarly, an induction generator cannot produce any electrical power when it is spinning at synchronous velocity. The synchronous motor/generator operates at synchronous speed by a mechanism introduced by Tesla. However, as stated AC induction motor/generators are functionally useless at this speed.

Slip: The ratio of the rotor frequency to the stator frequency is the slip. Motor slip is however, often expressed in percentage form. The slip is maximized at the moment of engagement and decreases as the motor accelerates. The slip over the motor range of operation is an object of motor design. At synchronous speed the motor slip is zero. A commercially available high torque, high slip motor may exhibit a load dependant slip range of from 5% to 8% or higher.

Efficiency and Electrical Rate Structures: There are various definitions of electromechanical conversion efficiency for motors, which may compare mechanical output power to electrical power input. Some simplified measurements take only electrical Watts into account. More general formulas include the Volt Amps required to operate the motor. This broader measurement is referred to as VA efficiency. Other formulas take into account the harmonic distortion and other electrical disturbances. Thus it has become routine for industrial users to select motive power systems and other energy conversion with one eye on the utility bill.

LC Stator Motor Designs: Electrical capacitors have been incorporated into single phase AC stator designs for over 80 years. These motor types classically include motor start, motor run, and motor start/motor run designs. In general these single phase LC motor stators have been composed of two winds. One wind is connected directly to the electrical source and the other is connected to the source through a capacitor. Various single phase stator winding systems have been developed over the years. The Wanlass and Smith motors are two notable examples which provided increases in power factor, torque, efficiency, bearing life and the like. Starting capacitors are regularly added to large and high torque requirement single phase motors.

Moment of Engagement: At the moment of engagement and in locked rotor conditions, the rotor is magnetically linked or coupled to its fullest extent to the stator by magnetic induction. At the moment of engagement this inductive coupling is at the fundamental frequency of the power supply. The magnetizing inrush currents and starting currents of induction motors profoundly lag the source voltage. The lagging currents associated with magnetizing inrush and starting currents are much greater than the full load currents of the motor. This low power factor requires a large source of magnetizing VARs to start the motor. These magnetizing VARs are generally provided by the grid synchronous generators. Steady state and transient VAR requirements can also be provided by capacitor banks along the grid and by other known means. These grid capacitor banks can be arranged in shunt, series or hybrid configurations.

Measuring and Calculating Motor Electrical Parameters: One may lock a rotor in place and reduce the source voltage to on the order of one quarter to one third the rated voltage in order to conduct certain electrical tests and determine motor parameters. Other electrical tests are conducted by altering the rotor velocity from synchronous speed to no load and progressively up to full load, service factor load and breakout torque load. Other stator electrical tests may be conducted with the rotor removed. Adjustable speed drive, frequency dependant electrical parameters may require substantially more performance characteristics.

Single Phase LC Motor Designs: Prior uses of capacitors in AC induction motor applications have generally involved electrical connections to the stator. These can be characterized as inductor/capacitor or LC stator designs. There have been a number of such motor designs and patents incorporating capacitors into single phase stator designs. These designs include, but are not limited to the Permanent Split Capacitor, Cravens Wanlass and J M Smith designs, which are reasonably characterized as high VA efficient single phase service induction motors. They thus exhibit high power factor and good Watt to HP electrical conversion efficiency. The VA efficiency can be calculated as the product of those two parameters in decimal form.

A classical Permanent Split Capacitor stator is shown in FIG. 3. The stator is connected to a single phase source and produces an approximation of a 2 phase revolving magnetic field by means of the phase shift between the inductor only branch on the right and the series inductor/capacitor branch on the left. This stator can be more specifically designed for various purposes. One common objective is to achieve an overall stator quasiresonant condition at or near the operational load where efficiency peaks. This and other design objectives involve sizing the capacitor and inductors in known manners. When additional starting torque is required, a starting capacitor is employed in shunt with the permanent (run) capacitor.

Wanlass Single Phase Induction Motors: The Wanlass single phase motor is generally a variation of the Permanent Split Capacitor stator shown above. Wanlass motors are also generally comprised of two stator winds, but of opposite dot convention, which may be connected on one end to the system neutral or common lead. A run capacitor is connected in series with one wind. The capacitor and remaining stator wind end are then connected to system hot lead. This widely used single phase motor design exhibits a defined rotational direction. The rotational direction can be reversed by a simple external reconnection. A generalized Wanlass Stator design is shown in FIG. 4. The ideal current displacement for the two winds of such single phase electrical motors is 90 degrees. This would provide for maximum torque. In most cases the Wanlass motor currents are reportedly displaced by approximately 60 degrees to 70 degrees from each other, typically at 67 degrees. This displacement will vary somewhat with load. This angular separation imparts a definite 120 Hz mechanical vibration to this type of motor. These motors will also tend to exhibit a lagging, unity or leading power factor in response to various load, voltage and component variations. It is not the intent here to fully describe these widespread motor systems in detail.

J. M. (Otto) Smith Induction Motors: The Smith motor generally involves a complex connection of a relatively standard 12 lead three phase motor to a single phase power supply. The 12 motor leads are generally connected in various known manners to form two half motors. At least two leads are generally connected to the system hot and common wires. The remaining motor leads are generally connected in a defined crisscross manner to each other with certain connections though one or more electrical capacitors. When additional starting torque is desired, the Smith motor designs employ one or more starting capacitors in a known manner. When the capacitor values are properly selected, the Smith stator currents are balanced and separated by approximately 120 degrees. Thus in full load operation, the Smith stator designs exhibit minimal 120 Hz mechanical vibrations. They will also typically perform at or near the rated efficiency of the motor for three phase voltage conditions. The Smith motor designs exhibit a leading power factor and can be employed to operate additional 3 phase satellite motors. The entire system can then be operated at or near unity power factor. It is not the intent to fully describe the Smith motor configurations.

Three Phase Capacitor Banks: Capacitors are sometimes placed in three phase service to correct power factor and to provide for the VAR requirements of the local loads. Capacitor banks may also be employed to provide for magnetizing VAR, inrush current, starting torque and power factor requirements of three phase motors and systems. There are well known undesirable effects associated with the use of these capacitor banks. For example stray harmonic and subharmonic resonances are frequently encountered in shunt and series capacitor installations on the grid. Also when motor flywheel behavior is present, a circuit disconnect upstream from a shunt capacitor bank may produce a destructive transient overvoltage condition. This overvoltage condition can persist in a phase voltage outage. Nonetheless the system electrical loss reduction, regulation improvement and generator fuel cost savings have motivated a large number of fixed and variable capacitance banks in electrical grids.

Three Phase Stator Designs: There is a significant need to increase grid VA efficiency, voltage regulation and other desirable factors by the use of capacitors. As a result, a number of induction motor designs incorporating capacitors into the stator have been introduced. These designs include the Hobart, Wanlass and Roberts three phase LC stator designs. 1. FIG. 11 is a schematic of an AC induction 3 phase—Hobart stator design. FIG. 12 is a schematic of a Wanlass stator prior art design. FIG. 13 is a schematic of a Robert stator prior art design. These motors have been widely studied in the literature. The designs, characteristics, advantages and limitations of these designs are well documented, though in some cases somewhat hotly debated. The various closed form and numerical mathematical modeling tools of existing stator, air gap and rotor designs are quite advanced.

One fundamental disadvantage of existing single phase and three phase motors is frequency or bandwidth related. The magnetic and electrical frequency of the rotor decreases as the motor accelerates. Thus where significant starting torque is required, at least two capacitor values are required, a run capacitor and a start capacitor. Steady state operation over the range of 0 to full load would require an even greater number of capacitor values. There is a significant challenge in optimizing the power factor, efficiency and thus VA efficiency of inductive machines over a wide range of loads. This challenge is further complicated by generation mode operation and alternate motor/generator service. Finally, the use of adjustable frequency power electronic devices with induction machines to form variable frequency or adjustable frequency drives (ASD) further increases the challenge. The bandwidth of ASDs may vary from a fraction of a Hertz up to several hundred Hertz.

Pulse Width Modulation (PWM) style and similar adjustable speed drives have in general a sinusoidal stator electrical current when connected to induction motors. The voltage however has spikes or momentary high magnitudes. The high voltage spikes create bearing problems in induction motors. The PWM high voltage spikes can produce a pitting on the bearing and race. This accelerates motor end of life.

Existing LC stator designs and other asynchronous motor capacitor circuit arrangements exhibit a degree of electrical self excitation.

The conventional motor capacitance requirements are much reduced, but vary somewhat between the speed at rated load and at no load speed. When the rotor is physically absent or is accelerated to synchronous speed, the capacitance required to correct the power factor of the stator is lower still. To provide motor start torque current requirements and steady state power factor correction, a large start capacitor and smaller run capacitor are required. This well known heuristic for AC induction motor capacitance requirements almost entirely neglects the rotor itself. It is well known that the limitations to induction motor capabilities are generally ferromagnetic related rather than conductor related. Also with advanced materials such as super conductors and high intensity magnetic and ferromagnetic materials, the frequency response of inductive machines becomes even more critical.

The general construction of the motor is shown in FIG. 21. The rotor is modified by the present invention. Capacitors are being added to the electrical path in at least some of the rotor conductors. These capacitors are electrically located at the ends of the iron lamination stacks. They are physically also located near the ends of the rotor iron laminations.

The rotor is the rotating part of the electric motor. Motors contain either a squirrel cage or wound rotor. Like the stator, rotors are constructed of a core wound with soft wire, but with the addition of a shaft and bearings. The shaft and bearings are supported by end caps, which allow the rotor to turn.

Squirrel cage rotors look somewhat like exercise wheels for hamsters. That is where they get their name. The rotor is made with conductive bars of soft metal, such as copper, brass, or aluminum, arranged in a cylindrical pattern around the shaft. The size, shape and resistance of these bars largely influence the characteristics of the motors that use them. See FIG. 22.

The bars are supported at each end by rings which also function to short-circuit the bars. In this way, a complete circuit is provided within the motor. The magnetic field from the stator induces an opposing magnetic field in the squirrel cage rotor bars. The rotor begins to turn since the bars are repelled by this field.

Often referred to as the “workhorse of the industry,” squirrel cage induction motors are inexpensive and reliable. They are suited to most applications and are readily available from suppliers.

The wound rotor operates on the same principle as the squirrel cage, but is designed differently. See FIG. 23. The wound rotor is constructed of windings, rather than shorted bars, which terminate at slip rings on the shaft. The attachment of external resistance to the slip rings, and thus to the rotor circuit, makes the variation of motor torque-speed characteristics possible.

A speed range variation of about five to one can be achieved through the addition of external resistance. This is at the expense of electrical efficiency, however, unless a slip energy recovery circuit is used. See FIG. 24.

The maximum torque that a wound rotor motor can produce depends upon the rotor's design. The rate at which maximum torque develops depends on external rotor resistance. Wound rotor induction motors are useful in many applications, because their rotor circuits can be altered to provide desired starting or running characteristics. FIG. 27 shows a cut-away drawing of a convention squirrel cage and wound rotor.

Since wound rotor motors require brush maintenance, initial cost and upkeep are typically higher than for squirrel cage motors. Wound rotor motors have, however, excellent starting torque and low starting currents.

Rotor Definition: The rotating component of an induction AC motor. It is typically constructed of a laminated, cylindrical iron core with slots of cast-aluminum conductors. Short-circuiting end rings complete the “squirrel cage,” which rotates when the moving magnetic field induces current in the shorted conductors. See in the FIG. 25 how the conventional squirrel cage rotor conductors form a solid short on both ends. This depicts a single wind motor. The laminated iron core is not shown in this drawing.

FIG. 26 shows a conventional squirrel cage rotor with shorting end caps. Note the skewed arrangement of the conductors, which helps to reduce cogging. Once again the rotor iron core is not included in this drawing.

The rotor iron core consists of a number of thin laminations, normally of silica steel such as the one shown in FIG. 28. These laminations are stacked vertically to a desired length to form the iron core.

Shown in FIG. 29 is an assembled conventional rotor and shaft.

The laminations are stacked together to form a rotor core as shown in the cutaway drawing illustrated in FIG. 30. Aluminum, copper or brass is die cast in the slots of the rotor core to form a series of conductors around the perimeter of the rotor. Current flow through the conductors forms the electromagnet. The conductor bars are mechanically and electrically connected with end rings in these conventional squirrel cage rotors. The rotor core mounts on a steel shaft to form a rotor assembly.

WOUND ROTOR MOTOR: Another motor type is the wound rotor. A major difference between the wound rotor motor and the squirrel cage rotor is the conductors of the wound rotor consist of wound coils instead of bars. These coils are connected through slip rings and brushes to external variable resistors. The rotating magnetic field induces a voltage in the rotor windings. Increasing the resistance of the rotor windings causes less current flow in the rotor windings, decreasing speed. Decreasing the resistance allows more current flow, speeding the motor up. See FIG. 31.

Thus we have in conventional rotors a single conductor per slot. The FIG. 32 shows an example two wind rotor cross sectional mechanical drawing. The outer cage and inner cage are electrically insulated from each other by the layer shown in blue. Each outer slot is electrically connected through at least one capacitor in this particular example. The inner core slot conductors can be wired together or shorted to each other by the end plate in this example. Capacitors can be run between the inner slots and the outer slots to electrically connect them to each other. So we could have shorting inner end rings and if desired, capacitive connection(s) from the shorting inner end rings to the outer end rings and/or capacitor connections.

Thus in the mechanical and electrical connections, the LC rotor wind of the instant invention is substantially different from existing rotors.

In adjustable speed drives, as frequency is increased, the effects of leakage inductance tend to become more significant. Thus the maximum available torque tends to decrease rapidly with increased frequency. Therefore a near-constant output power characteristic can be maintained only for a limited rotor speed range.

Thus there are significant needs for advanced induction machine methods and designs. Accordingly there is a need for inductive machine rotors with improved frequency response.

### BRIEF SUMMARY OF THE INVENTION

As used herein, the term “a” or “an” may mean one or more. As used herein in the claim(s), when used in conjunction with the word “comprising”, the words “a” or “an” may mean one or more than one. As used herein, “another” may mean at least a second or more.

As used herein, the term “capacitor” shall mean an electrical circuit element which is based on phenomena associated with electric fields. The source of the electric field is separation of charge, or voltage. If the voltage is varying with time, the electric field is varying with time. A time-varying electric field produces a displacement current in the space occupied by the field. The circuit parameter of capacitance relates the displacement current to the voltage. Energy can be stored in electric fields and thus in capacitors. The relationship between the instantaneous voltage and current of capacitors and the physical effects upon the capacitor are critical to capacitor improvements.

As used herein, the term “electrical charge storage device” shall mean any device capable of storing or producing an electrical field. Electrical charge storage devices generally include polarized capacitors, non polarized capacitors, electrochemical batteries, fuel cells, synchronous motors, synchronous generators, solar cells and the like. These electrical charge storage devices may be arranged in series, shunt, antiseries and biased antiseries with each other in known manners for a number of useful purposes by those familiar with the trade.

The present invention generally relates to the use of electrical charge storage devices in the rotors of induction machines. Optimal induction machine rotor electrical field requirements increase with rotational velocity and inversely to frequency. Pseudocapacitance and other inverse frequency capacitance adjustment methods are employed to provide for that need and thereby improve induction machine rotor performance parameters. Optimization of electrical reactance is the foundation for improvements in power transfer, torque, efficiency, stability, thermodynamics, vibration, thermodynamics and bearing life in rotational induction machines. LC rotor methods and designs are outlined herein to achieve these objectives.

In one aspect of the invention there is an improved induction machine rotor having at least one rotor wind, the induction machine rotor comprising at least one electrical charge storage device coupled to the at least one rotor wind. In one embodiment, the electrical charge storage is a non-polarized capacitor. The capacitor may be of various types, such as flat plate, wound, cylindrical, linear. In certain embodiments the electrical charge storage device is a quantum charge storage device, or a nanoscale storage device.

The invention may utilize an electrical charge storage device having enhanced surface area.

In various embodiments, the invention may utilize an electrical charge storage device that is a polarized capacitor. The polarized capacitor may be of various types, such as Electrolytic, Aluminum, Tantalum, Niobium, Rubidium, Titanium, Super, Ultra, Hybrid, double layer, valve metal, quantum, or Nanoscale.

In various embodiments, the invention may utilize an electrical charge storage device that is an asymmetrical capacitor, a symmetrical capacitor, an electrochemical battery, or a biased antiseries assembly of polarized electrical charge storage devices.

The electrical charge storage device utilized with the present invention may be adjustable or variable, a Pseudocapacitance electrical charge storage device, adjustable by surface area variation, adjustable by distance separation variation, adjustable by dielectric constant variation, adjustable by electrolyte variation, adjustable by temperature variation, adjustable by relaxation period variation, adjustable by centripetal variation, adjustable by electrical lead variation, adjustable by irradiation, adjustable by passive variation, adjustable by controlled variation, an electrical power supply operably connected to the one electrical charge storage device.

In various embodiments, the induction machine rotor of the present invention may be a squirrel cage rotor, or a wound rotor.

In another embodiment, the induction machine rotor is of a common stator design.

In one embodiment, the induction machine rotor is an LC rotor. In another embodiment, the induction machine rotor comprises an induction machine stator mechanically coupled to the LC rotor. In another embodiment, the induction machine rotor comprises an induction machine stator electromagnetically coupled to the LC rotor. In another embodiment, the induction machine rotor, comprises a mechanical load or prime mover, connected via a shaft to the LC rotor.

In one embodiment, the induction machine rotor comprises at least one bearing connected to an LC Rotor wind. Without limitation the bearing may be a magnetic bearing, journal bearing or load bearing. In other embodiments, the induction machine rotor comprises a magnetic field blocking, insulating or excluding device material. In another embodiment, the induction machine rotor has a rotor wind that is a single wind, with single shunt capacitor.

In another embodiment, the induction machine rotor has a rotor wind that is a single wind, with multiple shunt capacitors. In another embodiment, the induction machine rotor has a rotor wind that is a double wind, with single series capacitor. In another embodiment, the induction machine rotor has a rotor wind that is a double wind with each wind having the same Dot convention. In another embodiment, the induction machine rotor has a rotor wind that is a double wind with each wind having opposite Dot convention (or CW/CC).

In another embodiment, the induction machine rotor has a rotor wind that is a double wind, having a hybrid capacitor (i.e. series and shunt configuration) structure. In another embodiment, the induction machine rotor has a rotor wind that is a multiple wind, having a hybrid capacitor (i.e. series and shunt configuration) structure. In another embodiment, the induction machine rotor has comprises at least a pair of dissimilar capacitors in shunt, to tailor make an LC rotor of a desired frequency response.

One of many objects of the present invention is to connect electrical capacitors to the rotor of electrical motors. The various electrical connections described herein are representative of the great number of practical designs whereby electrical capacitors may be connected to rotors. Some of the benefits of connecting electrical storage devices are described hereinafter. The particular benefit or object achieved is applicable to the particular configuration of the capacitor and rotor, and as such may not apply in all cases. Benefits of embodiments include:

1) use of varying and adjustable capacitance capacitors in rotor design;

2) use of the phenomenon of pseudocapacitance in rotor designs is an object of this invention;

3) use of the capacitor phenomenon of dissipation in rotor designs is an object of this invention;

4) increase the bandwidth of constant Volts per Hertz control region of ASD;

5) increase higher effective rotor-circuit resistance during on-line starting, combined with a low effective rotor circuit resistance when the rotor frequency is low under running conditions;

6) increase the ratio of resistance to inductance for rotors;

7) increase the power factor of rotors and induction machines;

8) flatten the frequency response of rotors;

9) reduce cogging in rotors;

10) improve transient response of rotors and induction machines;

11) improve energy conversion efficiency of rotor and induction machines;

12) increase torque capability of rotors and induction machines;

13) reduce vibration in rotors and induction machines;

14) increase the rated value of stator flux linkage;

15) improve the power return efficiency to the stator when acting in generator mode;

16) reduce the level of linkage of integral multiple of stator frequency;

17) increase the maximum ASD stator frequency at which the full or rated stator flux linkage can be maintained;

18) increase the bandwidth of ASD constant power characteristic above maximum stator frequency;

19) reduce the effects caused by harmonics, especially those creating reverse phase sequence torque, such as the 5th harmonic;

20) reduce heat in the windings of rotors and stators;

21) reduce temperature of windings in rotors and stators;

22) reduce electrical power source harmonic currents and related heating;

23) mix in shunt fashion capacitor technologies to broaden the bandwidth of rotor operation;

24) reduce noise produced by rotors and induction machines;

25) reduce stray and parasitic resonances in AC networks and grids;

26) reduce magnetizing currents in rotors and induction machines;

27) improve power factor of transferred power to rotors and induction machines;

28) provide a degree of self excitation for rotors and induction machines;

29) reduce the requirement for grid maintenance and adjustment of capacitor banks;

30) reduce the production of oscillatory torque at the 6th, 12th and 18th harmonic frequencies;

31) reduce the effects of source voltage imbalance on induction machines;

32) reduce ASD jerky operation at low speed;

33) create rotors with inherent torque producing mechanisms;

34) create rotors with inherent velocity producing mechanisms;

35) increase rotor torque & induction machine torque;

36) starting torque;

37) steady state torque;

38) transient torque;

39) maximum torque;

40) breakdown torque;

41) increase rotor design acceleration control;

42) starting acceleration;

43) transient acceleration;

44) maximum acceleration;

45) alter VAR input and output capabilities of asynchronous machines;

46) increase operational speed range of rotors and induction machines;

47) increase slip design control;

48) reduce the severity and duration of light flicker due to motor starting;

49) improve voltage regulation to motor terminals; and

50) translate a number of known inductor capacitor (LC) stator design techniques and topologies across the air gap to the rotor.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a graph illustrating Pseudocapacitance;

FIG. 2 is a drawing of a squirrel cage rotor;

FIG. 3 is a schematic of a permanent split capacitor LC stator design

FIG. 4 is a schematic of a Wanlass LC stator design;

FIG. 5 is a schematic of a series LC rotor design;

FIG. 6 is a schematic of a split phase LC rotor design;

FIG. 7 is a schematic of a split phase LC rotor detail;

FIG. 8 is a schematic of a double cage rotor;

FIG. 9 is a schematic of a lumped parameter conventional rotor drawing;

FIG. 10 is schematic of a lumped parameter LC rotor block drawing;

FIG. 11 is a schematic of an AC induction 3 phase—Hobart stator design;

FIG. 12 is a schematic of a Wanlass stator prior art design;

FIG. 13 is a schematic of a Robert stator prior art design;

FIG. 14 is a cutaway sketch of an LC Rotor design;

FIG. 15 is a cutaway sketch of an LC Rotor design;

FIG. 16 is a cutaway sketch of an LC Rotor design;

FIG. 17 is a cutaway sketch of an LC Rotor design;

FIG. 18 is a cutaway sketch of an LC Rotor design;

FIG. 19 is a cutaway sketch of an LC Rotor design;

FIG. 20 is a schematic of a variable capacitance rotor;

FIG. 21 is an illustration of a common motor design;

FIG. 22 is an illustration of a squirrel cage induction motor;

FIG. 23 is an illustration of a wound rotor;

FIG. 24 is an illustration of a schematic using speed variation with external resistors;

FIG. 25 is an illustration of a typically constructed laminated, cylindrical iron core with slots of cast-aluminum conductors for an induction AC motor;

FIG. 26 is an illustration of a conventional squirrel cage rotor with shorting end caps;

FIG. 27 is an illustration of a squirrel cage and wound rotor design;

FIG. 28 is an illustration of a rotor iron core with a number of thin laminations, normally of silica steel;

FIG. 29 is an illustration of an assembled conventional rotor and shaft;

FIG. 30 is an illustration of a laminations stacked together to form a rotor core as shown in the cutaway drawing;

FIG. 31 is an illustration of a wound rotor; and

FIG. 32 is an illustration of a an example two wind rotor cross sectional mechanical drawing

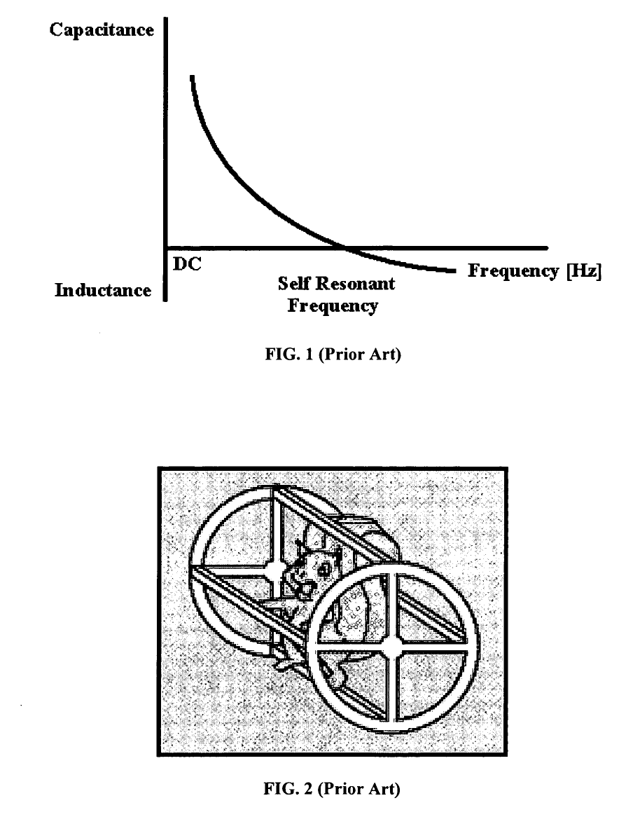

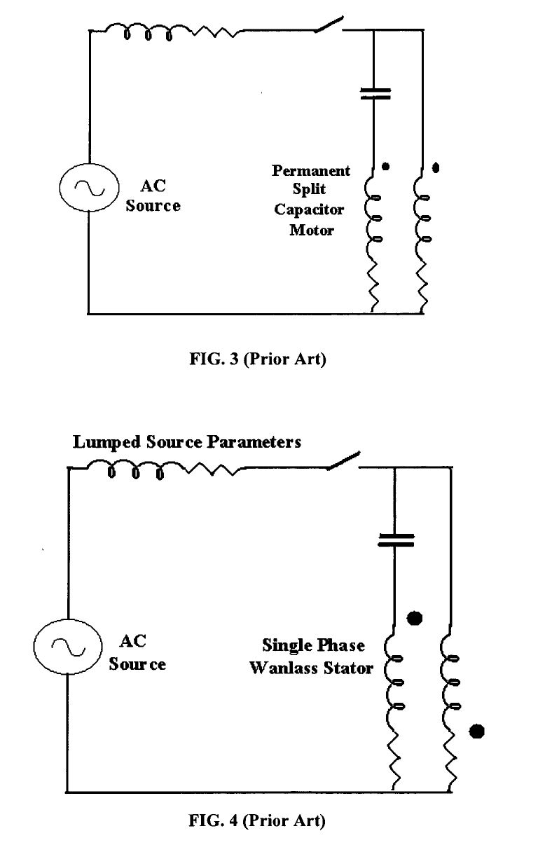

### DETAILED DESCRIPTION OF THE INVENTION

The rotor core and winds form an inductive circuit element. One or more capacitors can be added to the rotor to generally increase the power factor and thereby increase the power transfer and power conversion characteristics of the device. It is well known that capacitors and inductors can be combined in various LC configurations. These configurations can include series, shunt and hybrid combinations of the circuit elements.

At the moment of engagement of an induction motor, the rotor is generally motionless. At this instant the stator and rotor are electromagnetically coupled to their greatest extent. Significant magnetizing VARs are required by induction motors at the moment of engagement. As the rotor within the induction machine accelerates, the electrical frequency in the rotor decreases. To maintain a resonant or quasiresonant electrical circuit in the rotor as the rotor electrical frequency is changed, a variation of capacitance is required.

A simple LC rotor is shown in FIG. 5, titled Series LC Rotor Design. A rotor of this type would require an infinite capacitance to resonate at synchronous speed. Of course induction motor rotors can not produce torque to achieve synchronous speed. Similarly induction generators produce no electricity at synchronous speed. The top rotor speed of a rotor constructed to match this design would tend to be limited by capacitance. Within the normal operational load and design speed of the motor, a finite, but variable capacitance is required to achieve quasi resonance. Composed of a single inductor (L) and a single capacitor per circuit, the inductance of this LLC rotor circuit can be modeled by first order differential equations and relatively simple iterative methods. In symmetric realizations, the physical parts count is of course larger. So for example an induction rotor with 64 slots can be physically constructed with only one capacitor or a pair of biased antiseries polarized capacitors, by means of a brush like structure, as commonly used in DC motors. Use of symmetry will permit 2, 4, 8, 16, 32, 64, 128, or more than 256 capacitors while this circuit model remains mathematically valid. The highest numbers assumes the use of antiseries capacitor assemblies at each end of each rotor bar. Antiseries polarized capacitor biasing methods, circuits, heuristics, techniques and designs are reasonably well known. The lumped source parameters relate to stator and air gap characteristics, which functions and mathematic models are well known to those in the trade.

The capacitance requirements to optimize rotor operation are quite different from those seen from the stator side of the air gap. Consider a rotor of a known inductance at a selected frequency. Sixty Hertz is selected as a reference frequency though any single frequency in the range of operation of the motor or adjustable speed drive can be reasonably considered. The inductive reactance is typically calculated as the product of inductance frequency and the constant two-Pi. Thus:

### Radian Inductive Reactance Formula

X_{L}=F₀*2Pi*L Equation 6

Consider the common North American fundamental frequency of 60 Hz.
X_{L60}=60*2Pi*L

For 60 Hertz, the inductive reactance is approximately 377 times the inductance. This condition corresponds to rotor inductance at the moment of engagement.

Next we will consider the inductive reactance for the same inductance electrified by a 3 Hertz signal.
X_{L3}=3*2 Pi*L

For 3 Hertz the inductive reactance is calculated as approximately 19 times the inductance. This rotor frequency would correspond to a significant load on some small induction motors.

Now we will calculate the inductive reactance associated with a 1 Hertz signal.
X_{L1}=2 Pi*L

For 1 Hertz the inductive reactance is calculated as approximately 6.25 times the inductance. The range of values considered from 1 Hertz to 3 Hertz produced an inductive reactance variation of 300%.

The capacitive reactance of a capacitor is given as 1 divided by the sum of the capacitance times the frequency times the scalar 2 Pi.
X_{C}=1/(F₀*2 Pi*C)

Now consider the capacitive reactance and capacitance required to offset this inductive reactance. The magnitude of the capacitive reactance in a simplified, (neglecting resistance) series resonant circuit is equal to the magnitude of the inductive reactance of that circuit. The more detailed formula is readily obtained from the literature and is relatively simple to derive.
X_{C}=X_{L} (Series Resonance Approximation, Neglecting Resistance)
1/(F*2 Pi*C)=F*2 Pi*L
C=1/(F*2 Pi*F*2 Pi*L)
C=1/(L(2 PiF)²)
Or:
C=1/(39.48*F²*L)

A representative 3PP high slip induction rotor may have a rotational speed variation on the order of 46.3 RPM from a 50% Load speed of 1172.6 RPM to a speed of 1126.3 RPM at a 125% load. Therefore at 50% load the rotor is exposed to an electrical frequency of:
1172.6/1200=F/60
F=60*(1200−1172.6)/1200
F=(1200−1172.6)/20
F=(27.4)/20
F=1.37 Hertz
C₅₀=1/(39.48*1.372*L)
C₅₀=1/(39.48*L*1.37²)
C₅₀=1/(39.48*L*1.88)

And for a 125% load the rotor electrical frequency is
F=(1200−1126.3)/20
F=(73.7)/20
F=3.685 Hertz

Therefore the capacitance value required at a 125% load is given by:
C₁₂₅=1/(39.48*3.685²*L)
C₁₂₅=1/(39.48*L*3.685²)
C₁₂₅=1/(39.48*L*3.685²)
C₁₂₅=1/(39.48*L*13.58)

As a result we find that the capacitance required for a 50% load (1.37 Hz) is approximately 7.22 times the capacitance required at a 125% load (3.685 Hz). Therefore a capacitor which exhibits a gain in capacitance of this magnitude over the selected frequency range given will tend to maintain the rotor in a state of quasiresonance over that range. In that the power transfer theorem states that power transfer is maximized in the vicinity of resonance, this magnitude of capacitance variation would provide for an optimal power transfer to the rotor in this condition.

It should be noted that a capacitance variation that is greatly off target may give rise to an undesirable harmonic or subharmonic resonance at that frequency. Physically small capacitors that exhibit the desirable frequency response are required in this application. The challenging mechanical and thermodynamic environment present within rotors further directs the acceptable capacitor realizations.

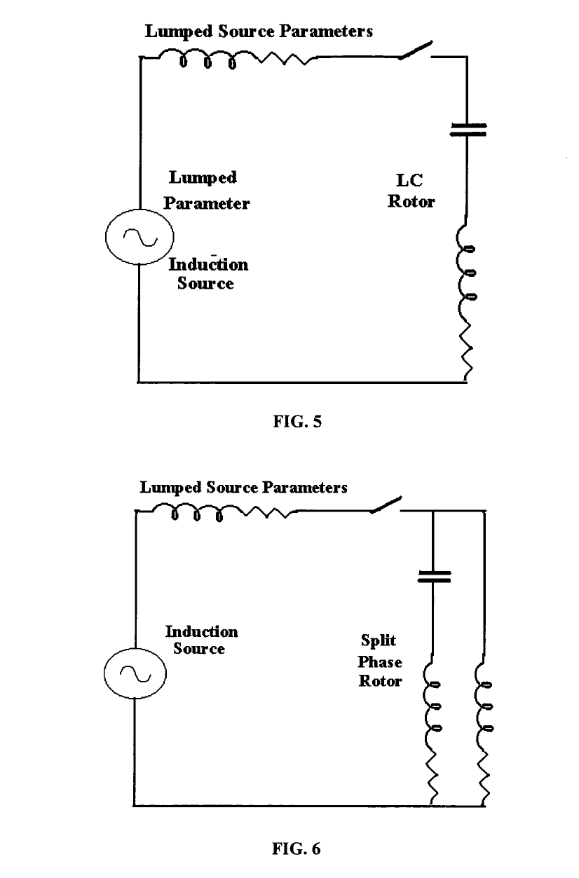

Another LC Rotor design, designated the Split Phase LC Rotor, or LLC Rotor is shown in FIG. 6. Note the common connection at the base of the rotor block drawing. This connection corresponds to a standard squirrel cage end. On the upper connection, one conductor connection corresponds to a squirrel cage connection, while the other conductor is connected through a capacitor. There are a number of variations possible within this generalized design.

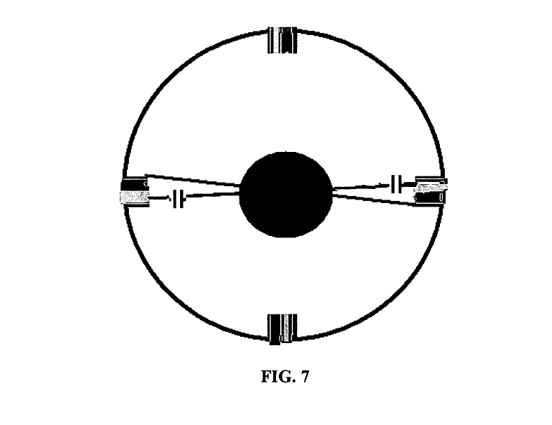

Referring to FIG. 7, Split Phase Rotor Detail, the figure shows one pair of insulated rotor conductors interconnected across the span of the rotor in this manner. The current phase shift between these conductors occupying the same slot provides for greater rotor current and torque. When the capacitance is properly sized for the inductances involved, a complex resonance can be approached. The series inductor capacitor combination can serve as a shunt capacitance for the parallel inductor only conductor. Thus a mechanism exists herein to amplify both voltage and current in a rotor. In this figure, the rotor conductors are shown in a side by side pattern. One capacitor may be employed instead of two, or alternately, the second capacitor may be relocated to the other end of the rotor. It is not intended to detail all the design options and objectives of series, shunt and hybrid combinations of conductors, capacitors, inductors, resistors, diodes, MOVs, semiconductors and other circuit elements routinely in use in stator, filter, power electronic and electronic circuits. The use of pseudocapacitance, adjustable, controllable and expanded surface area capacitors in rotors can be accomplished by many specific and configurable methods, to accomplish a variety of application engineering requirements.

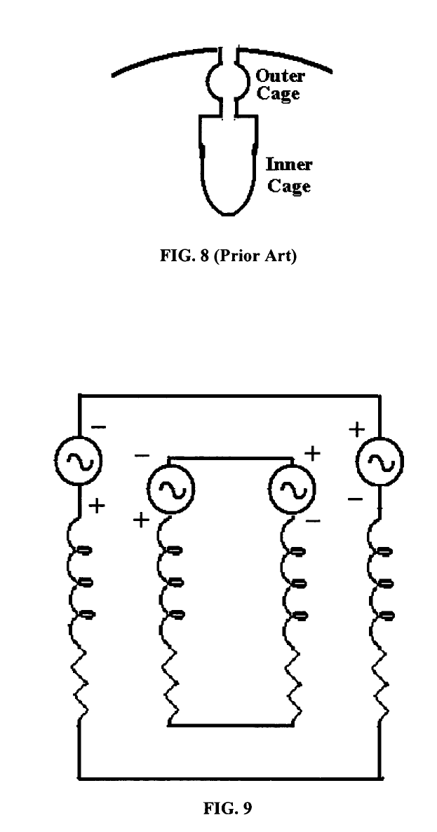

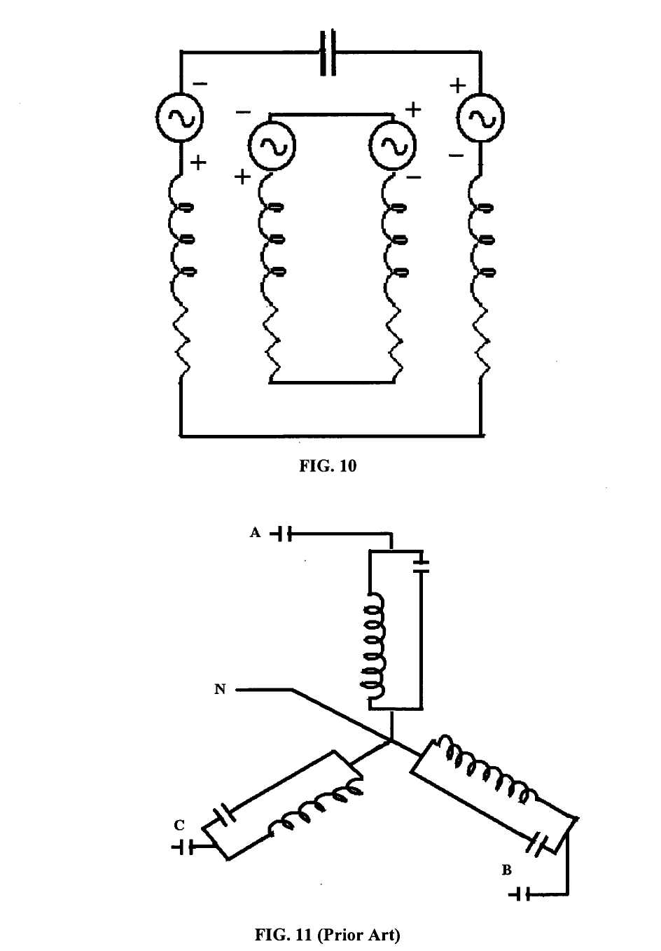

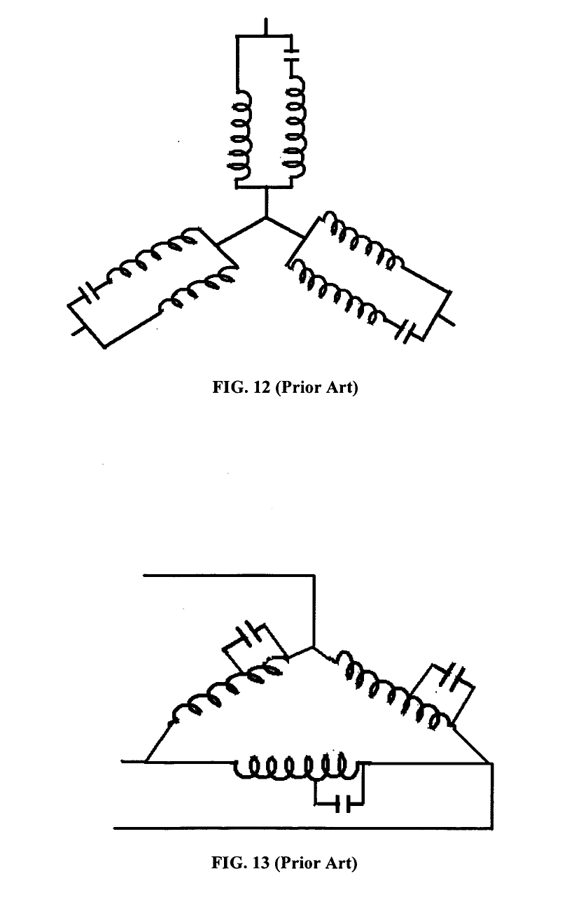

It is well understood that various shapes of speed-torque relationships can be achieved by varying the rotor cage shapes and air gaps between them. A two cage rotor, titled Double Cage Rotor, is shown in FIG. 8. Rotor cage topology of this sort may feature an outer cage of relatively small cross sectional area, and a more deeply buried cage with a greater cross sectional area. The outer cage is mainly dependent on the tooth-to-tooth air gaps above the cage connectors. It will exhibit high resistance and low inductance, which is useful for starting torque. This characteristic can be enhanced by inclusion of capacitors. The inner cage demonstrates a higher inductance and lower resistance, which is more useful for efficiency at high rotor speeds and the associated low frequencies. Various degrees of symmetry and asymmetry can be employed in LC Rotor construction to achieve a desired frequency response and provide for stray resonance damping. A wide variety of rotor cage shapes are used to achieve specific induction machine design and performance purposes.

FIG. 9 is a block drawing representing the lumped parameters of a conventional rotor. An AC source is shown in each slot position. The instantaneous polarities of the slots are depicted for reference. The outer cage is typically more resistive and predominates in motor starting. The inner cage is more highly inductive and thus increases in importance at operating velocities. The rotor electrical behavior modeled in this figure approximates the circuit behavior of typical squirrel cage motors. Though the squirrel cage rotor is shorted at the end plates, the electrical parameter differences of the inner and outer cages are somewhat accurately depicted in this figure. The inner cage current substantially lags the outer cage current at the moment of engagement. At near synchronous velocities, the rotor currents are more evenly distributed across the cross sectional area of the slots.

FIG. 10 depicts an LC rotor, where a capacitor has been included in the circuitry of the outer slots. The outer slot current will profoundly lead the inner slot current due to the presence of the capacitor. Where properly tuned and configured, the greater current lead can serve to reduce cogging and increase rotor torque.

The optimal capacitance values for the various LC rotor designs can be calculated as shown above, derived using motor parameter derivation methods, calculated from first principles, iteratively solved for using finite difference calculation methods and may alternatively be measured by use of locked rotor techniques when inductively energized across the air gap by an adjustable speed drive and by a number of other satisfactory engineering methods.

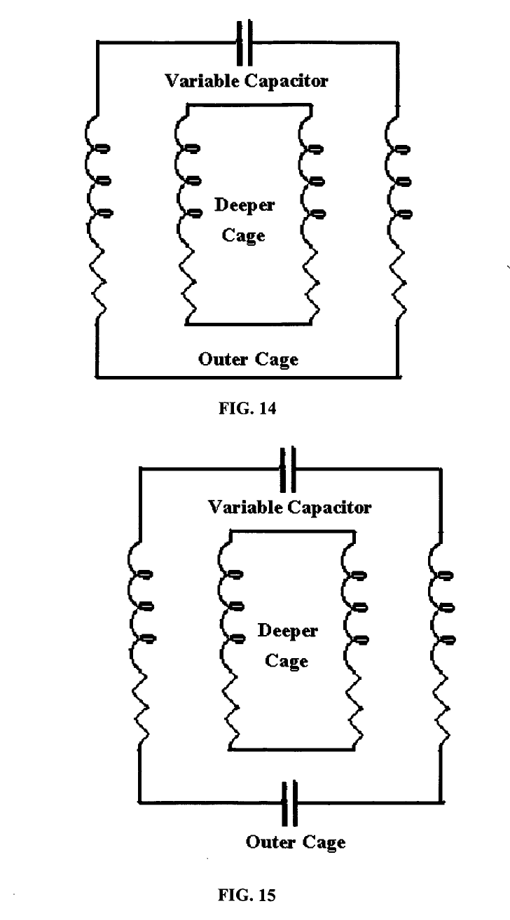

FIG. 14 depicts a simple LC rotor longitudinal cross sectional slice. This representation shows a pair of rotor slots, each consisting of an outer cage and deeper (inner) cage. The rotor slots are physically and electrically separated by approximately 1800. The outer cage conductor may be electrically insulated from the inner cage in this realization. The left and right inner cage conductors are connected by conductors at each end (i.e. shorted together). The rotor inner cage electrical current lags the impressed voltage. The outer cage conductors are connected on one end by a conductor and on the other end through a capacitor. The capacitor in series with the outer slot conductors alters the voltage/current relationship. The current in the rotor outer slots may lag, phase lock or lead the impressed voltage depending on the capacitance value at a particular rotational velocity.

Rotor velocity and torque are functionally related to the frequency and magnitude of rotor electrical current. As the rotor velocity increases, the rotor electrical frequency decreases. Increased capacitance is required at lower frequency in LC circuits. Thus, the operation of the outer cage and the rotor as a whole is enhanced by increasing the capacitance as the rotational velocity of the rotor increases. Thus a variable capacitor is selected to optimize the operation of the LC rotor over a range of frequencies.

FIG. 15 depicts a simple LC rotor longitudinal cross sectional slice. FIG. 15 includes capacitor coupling of the outer cage at both ends. The inner cage ends are connected by electrical conductors at both ends.

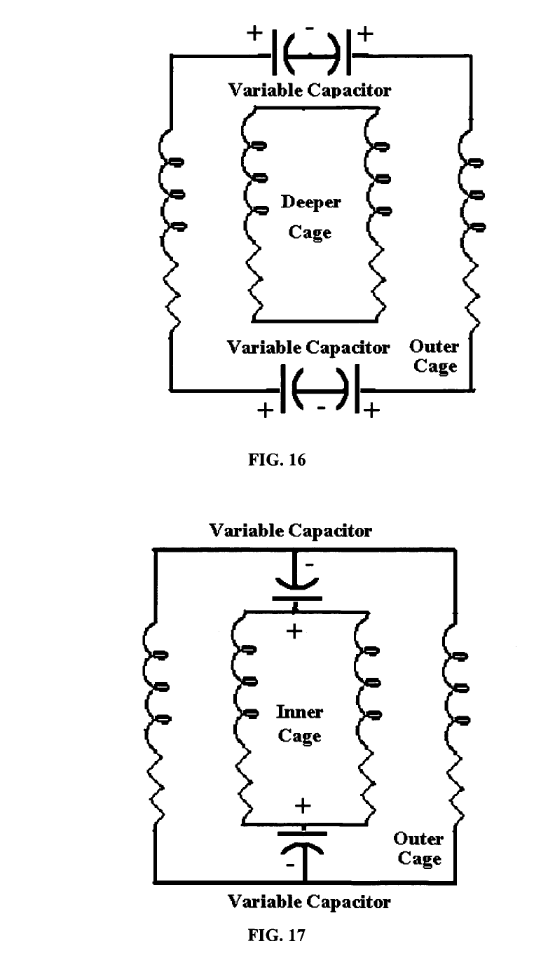

FIG. 16 depicts a simple LC rotor longitudinal cross sectional slice. The variable capacitors shown in this representation are biased antiseries polarized capacitors. The bias circuitry is omitted from this drawing. The inner cage ends are connected by electrical conductors at both ends.

FIG. 17 depicts a simple LC rotor longitudinal cross sectional slice. The outer cage slot conductors are capacitively coupled. The inner cage ends are connected by electrical conductors at both ends. The outer and inner conductors are interconnected connected by capacitors at the top and bottom. Capacitors provide a current path between the outer and inner slot conductors. A DC bias offset voltage is shown between the inner and outer slot conductors in this LC rotor realization.

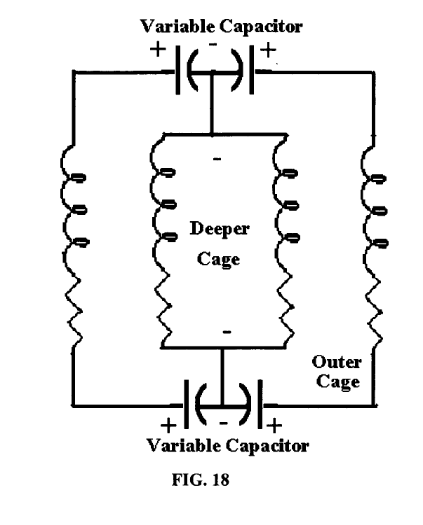

FIG. 18 depicts another simple LC rotor longitudinal cross sectional slice. In this realization the outer rotor cage slot conductors are connected in series with variable capacitors. The inner cage ends are connected by electrical conductors at both ends. The deeper cage is connected to the center node of the antiseries pairs of capacitors, providing a capacitive current path between inner and outer cage conductors. The inner and outer cage conductors are at differing DC voltages in this realization.

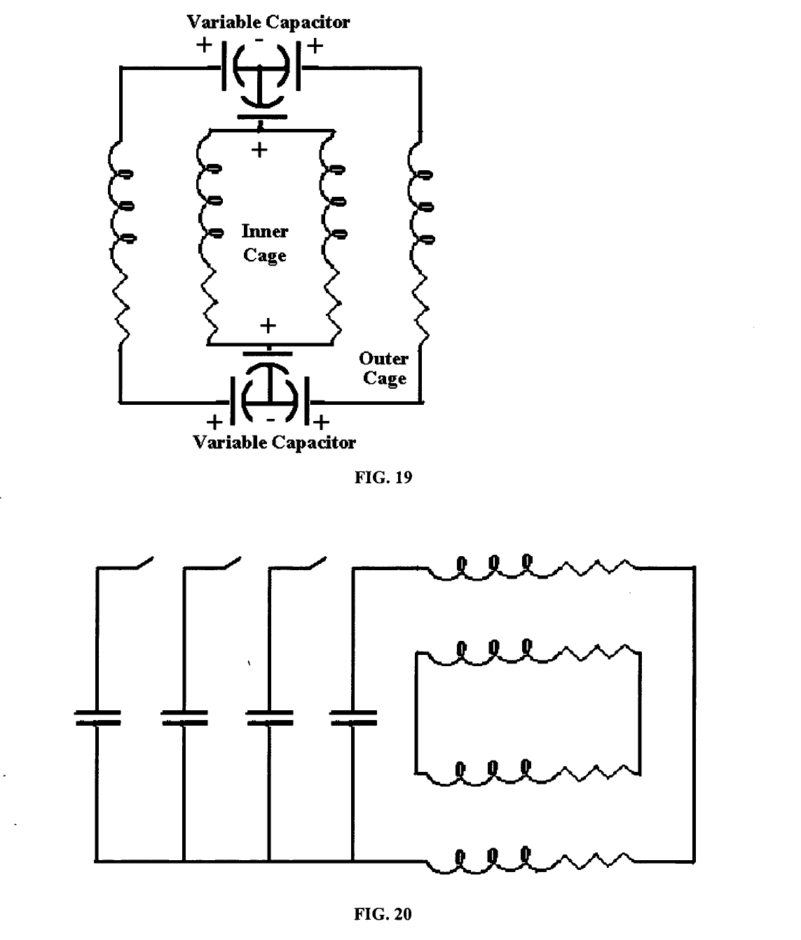

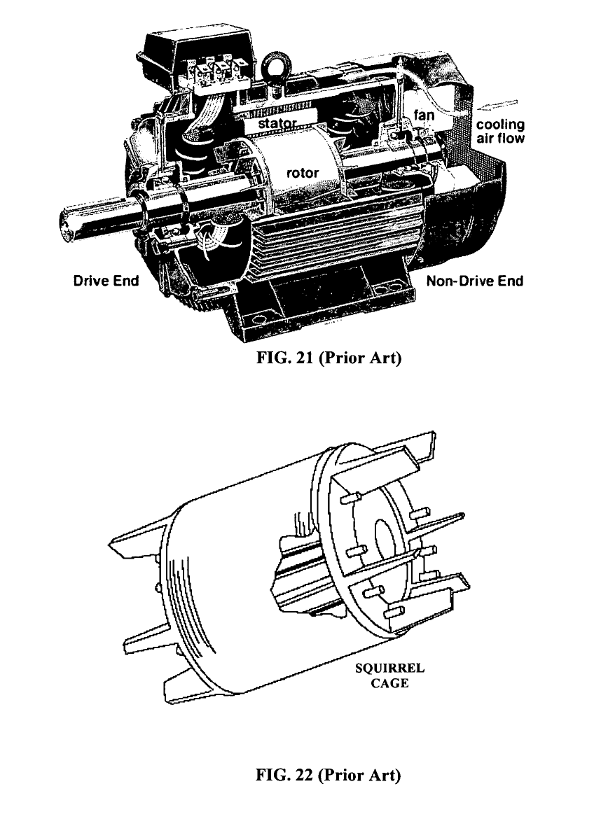

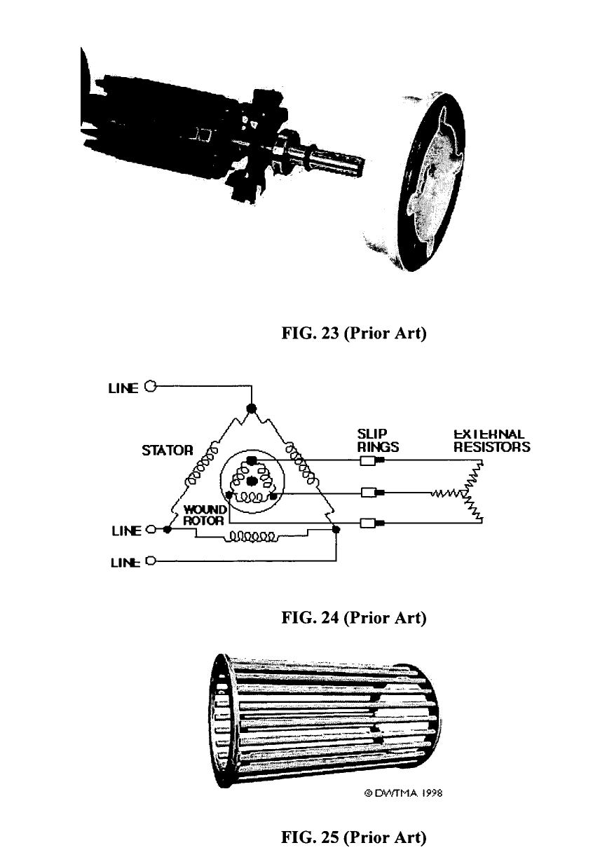

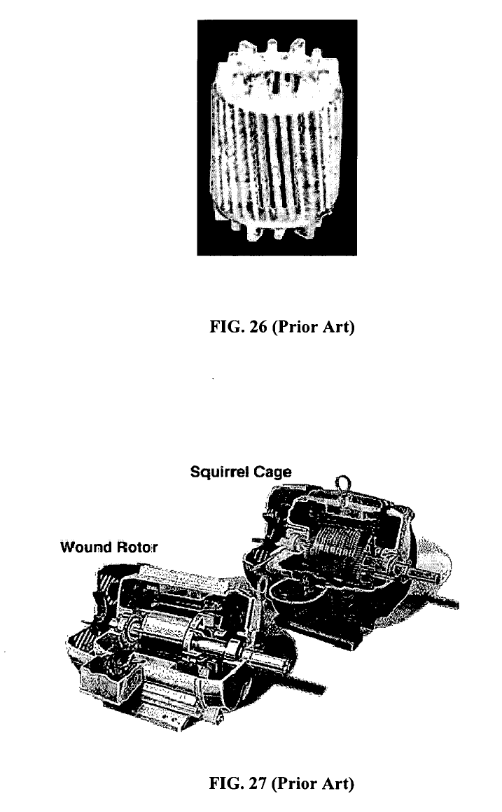

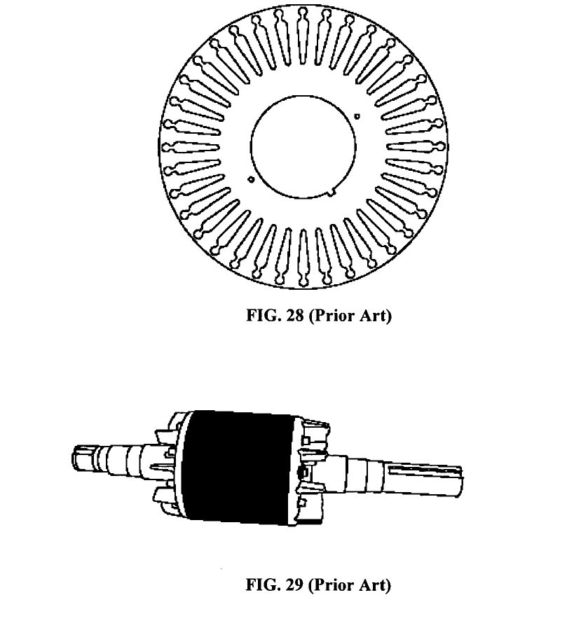

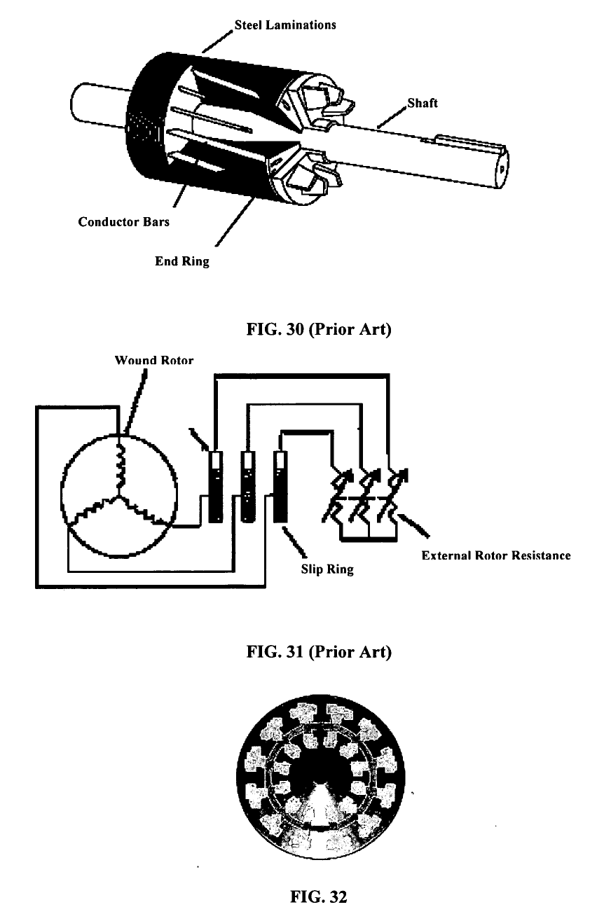

FIG. 19 depicts yet another simple LC rotor longitudinal cross sectional slice. In this realization the outer rotor cage slot conductors are connected in series with variable capacitors. The inner cage ends are connected by electrical conductors at both ends. A capacitive current path is provided between the inner and outer slot conductors in this rotor design. In this representation, the inner and outer cage conductors can be maintained at the same DC potential. Also, differing effective capacitance values can be used in the outer series connection and the capacitive coupling circuitry between the inner and outer cage conductors.

The block drawing of FIG. 20 depicts an LC rotor implementation. The rotor AC induction electrical sources are omitted for simplicity. At the moment of engagement, in an induction motor, only the fixed capacitor is connected. As the rotor mechanical rotational velocity accelerates and the rotor electrical frequency decreases, additional capacitance is added by the closing of the switches. Also as the rotor electrical frequency decreases, the deep cage rotor torque contribution increases. The switching realization may be mechanical, electromechanical or solid state. The switch control mechanism may be mechanical, analog or digital in nature. A state of electrical resonance, quasiresonance and/or pseudo resonance may be maintained at a selected frequency or across a selected frequency range by proper adjustment of the circuit capacitance. The number of switches, switching circuit topology and selectable capacitor values may of course be enhanced to extend the favorable results. This mechanism may similarly be realized in whole or in part by use of frequency dependant capacitor elements, such as those exhibiting pseudocapacitance and other such variable capacitance phenomena. These variable and/or adjustable capacitor rotor mechanisms may be extended to adjustable frequency drives and similar generalized induction machine rotors.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. An improved induction machine rotor having at least one rotor wind, said induction machine rotor comprising:
at least one electrical charge storage device coupled to said at least one rotor wind.

2. The induction machine rotor of claim 1, wherein the electrical charge storage device is a non-polarized capacitor.

3. The induction machine rotor of claim 2, wherein said capacitor is flat plate.

4. The induction machine rotor of claim 2, wherein said capacitor is wound.

5. The induction machine rotor of claim 2, wherein said capacitor is cylindrical.

6. The induction machine rotor of claim 2, wherein said capacitor is linear.

7. The induction machine rotor of claim 1, wherein the electrical charge storage device is a quantum charge storage device.

8. The induction machine rotor of claim 1, wherein the electrical charge storage device is a nanoscale storage device.

9. The induction machine rotor of claim 1, wherein the electrical charge storage device has enhanced surface area.

10. The induction machine rotor of claim 1, wherein the electrical charge storage device is a polarized capacitor.

11. The induction machine rotor of claim 10, wherein the polarized capacitor is one of the following: Electrolytic, Aluminum, Tantalum, Niobium, Rubidium, Titanium, Super, Ultra, Hybrid, double layer, valve metal, quantum, or Nanoscale.

12. The induction machine rotor of claim 1, wherein the electrical charge storage device is an asymmetrical capacitor.

13. The induction machine rotor of claim 1, wherein the electrical charge storage device is a symmetrical capacitor.

14. The induction machine rotor of claim 1, wherein the electrical charge storage device is an electrochemical battery.

15. The induction machine rotor of claim 1, wherein the electrical charge storage device is a biased antiseries assembly of polarized electrical charge storage devices.

16. The induction machine rotor of any one of claim 1 wherein the electrical charge storage device is adjustable or variable.

17. The induction machine rotor of claim 1 wherein the electrical charge storage device is a Pseudocapacitance electrical charge storage device.

18. The induction machine rotor of claim 1, wherein the electrical charge storage device is adjustable by surface area variation.

19. The induction machine rotor of claim 1, wherein the electrical charge storage device is adjustable by distance separation variation.

20. The induction machine rotor of claim 1, wherein the electrical charge storage device is adjustable by dielectric constant variation.

21. The induction machine rotor of claim 1, wherein the electrical charge storage device is adjustable by electrolyte variation.

22. The induction machine rotor of claim 1, wherein the electrical charge storage device is adjustable by temperature variation.

23. The induction machine rotor of claim 1, wherein the electrical charge storage device is adjustable by relaxation period variation.

24. The induction machine rotor of claim 1, wherein the electrical charge storage device is adjustable by centripetal variation.

25. The induction machine rotor of claim 1, wherein the electrical charge storage device is adjustable by electrical lead variation.

26. The induction machine rotor of claim 1, wherein the electrical charge storage device is adjustable by irradiation.

27. The induction machine rotor of claim 1, wherein the electrical charge storage device is adjustable by passive variation.

28. The induction machine rotor of claim 1, wherein the electrical charge storage device is adjustable by controlled variation.

29. The induction machine rotor of claim 1, further comprising an electrical power supply operably connected to said one electrical charge storage device.

30. The induction machine rotor of claim 1, wherein said induction machine rotor is electrically and mechanically adapted from a squirrel cage type rotor.

31. The induction machine rotor of claim 1, wherein said induction machine rotor is electrically and mechanically adapted from a conventional wound rotor design.

32. The induction machine rotor of claim 1, wherein induction machine stator is electrically and mechanically adapted from a common rotor design.

33. The induction machine rotor of claim 1, wherein said induction machine rotor is an LC rotor.

34. The induction machine rotor of claim 1, further comprising at least one bearing connected to an LC Rotor shaft.

35. The induction machine rotor of claim 34, wherein said bearing is a magnetic bearing, journal bearing or load bearing.

36. The induction machine rotor of claim 33, further comprising an induction machine stator mechanically coupled to said LC rotor.

37. The induction machine rotor of claim 33, further comprising an induction machine stator electromagnetically coupled to said LC rotor.

38. The induction machine rotor of claim 33, further comprising a mechanical load or prime mover, connected via a shaft to said LC rotor.

39. The induction machine rotor of claim 1, wherein said rotor wind is a single wind, with single shunt capacitor.

40. The induction machine rotor of claim 1, wherein said rotor wind is a single wind, with multiple shunt capacitors.

41. The induction machine rotor of claim 1, wherein said rotor wind is a double wind, with at least one series capacitor.

42. The induction machine rotor of claim 42, wherein said rotor wind is a double wind with each wind having the same Dot convention.

43. The induction machine rotor of claim 42, wherein said rotor wind is a double wind with each wind having opposite Dot convention (or CW/CC).

44. The induction machine rotor of claim 1, wherein said rotor wind is a double wind, having a hybrid capacitor (i.e. series and shunt configuration) structure.

45. The induction machine rotor of claim 1, wherein said rotor wind is a multiple wind, having a hybrid capacitor (i.e. series and shunt configuration) structure.

46. The induction machine rotor of claim 1, further comprising at least a pair of dissimilar capacitors in shunt, to tailor make an LC rotor of a desired frequency response.
